(19) United States
(12) Patent Application Publication
(10) Pub. No.: US 2025/0090905 A1
(43) Pub. Date: Mar. 20, 2025

(54) SYSTEMS AND METHODS FOR FITNESS CLASS GENERATION

(71) Applicant: Anytime Movement, LLC, Nashua, NH (US)

(72) Inventors: James L Jacobs, II, Nashua, NH (US); Jonas Amberger, Eliot, ME (US)

(73) Assignee: Anytime Movement, LLC, Nashua, NH (US)

(21) Appl. No.: 18/368,867

(22) Filed: Sep. 15, 2023

(51) Int. Cl. A63B 24/00

(52) U.S. Cl. CPC A63B 24/0075; A63B 24/0006

(57) ABSTRACT

Disclosed herein are systems and methods for fitness class generation. In some embodiments, a fitness class is generated by capturing class action data, such as video, via a video capture device, analyzing the class action data, determining a class action data modifier, and generating fitness class content as a function of the class action data.

### FIELD OF THE INVENTION

The present invention generally relates to the field of artificial intelligence. In particular, the present invention is directed to systems and methods for fitness class generation.

### BACKGROUND

Virtual fitness class instruction is in many cases not reactive to the performance of class participants.

### SUMMARY OF THE DISCLOSURE

In an aspect, disclosed herein is an apparatus for fitness class generation, the apparatus comprising: a video capture device; and a computing device communicatively connected to the video capture device, wherein the computing device comprises: at least a processor; and a memory communicatively connected to the at least processor, the memory containing instructions configuring the at least processor to: receive class action data from the video capture device; analyze the class action data using an action module; determine a class action data modifier based on an analysis of the class action data; and generate fitness class content as a function of the class action data modifier.

In another aspect, disclosed herein is a method of generating fitness class content, the method comprising: receiving class action data from a video capture device; analyzing the class action data using an action module; determining a class action data modifier based on an analysis of the class action data; and generating fitness class content as a function of the class action data modifier and the class action data.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a diagram depicting an exemplary apparatus for fitness class generation.

FIG. 2 is a diagram depicting an exemplary machine learning module and related data and processes.

FIG. 3 is a flow diagram depicting an exemplary method of generating a fitness class.

FIG. 4 is a diagram depicting an exemplary neural network.

FIG. 5 is a diagram depicting an exemplary neural network node.

FIG. 6 is a diagram depicting an exemplary fuzzy set.

FIG. 7 is a diagram depicting an exemplary computing device.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for fitness class generation.

An apparatus for fitness class generation may include a video capture device and a computing device. A video capture device may capture video or audio of a fitness class. A video capture device may store video or audio of a fitness class. A computing device may receive class action data, such as video of instructors and participants, from a video capture device. A computing device may analyze class action data using an action module and may determine a class action data modifier based on this analysis. For example, a computing device may use a computer vision model to analyze the pose a class participant takes, and if the pose is flawed, may determine a class action data modifier that alters fitness class content such that it includes guidance on correcting the pose. A computing device may generate fitness class content as a function of the class action data modifier and the class action data. For example, a computing device may generate fitness class content by selecting class action data to display, or by combining segments of class action data. For example, a computing device may generate fitness class content by combining, in a first scene, audio of a live instructor and video of a live class participant performing a pose correctly, and, in a second scene, audio of a live instructor and video of an instructor teaching a previous class. A computing device may provide a visual interface. A visual interface may be used by an instructor, class participants, or both. A visual interface may display fitness class content. A fitness class may display one or more interactive elements, such as a button for requesting additional guidance.

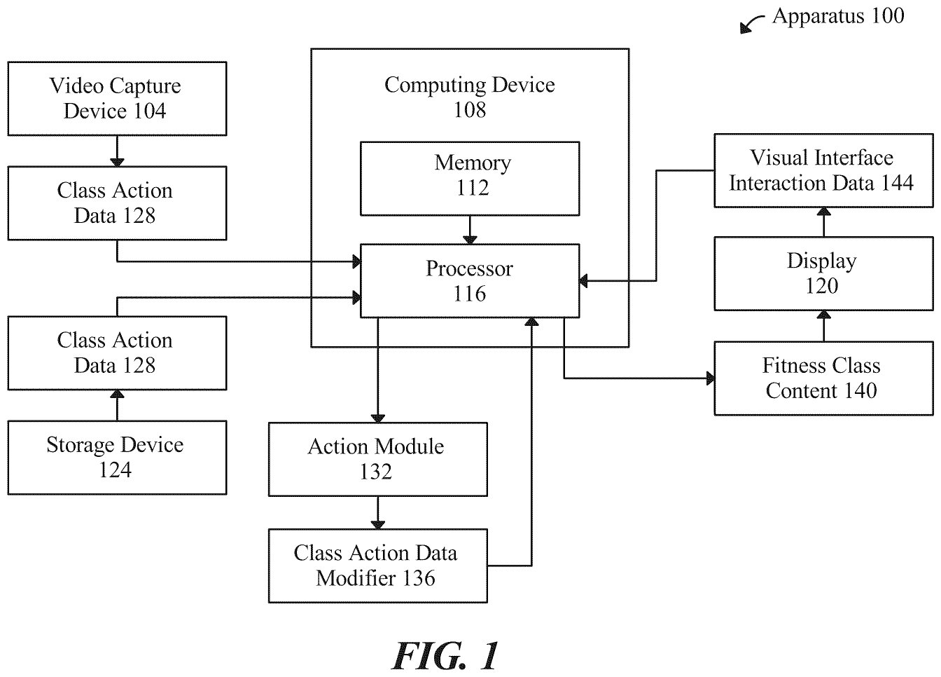

Referring now to FIG. 1, an exemplary embodiment of an apparatus for fitness class generation is illustrated. An apparatus may include a computing device. An apparatus may include a processor. A processor may include, without limitation, any processor described in this disclosure. A processor may be included in a computing device. An apparatus may include any computing device as described in this disclosure, including without limitation a microcontroller, microprocessor, digital signal processor (DSP) and/or system on a chip (SoC) as described in this disclosure. An apparatus may include, be included in, and/or communicate with a mobile device such as a mobile telephone or smartphone. An apparatus may include a single computing device operating independently, or may include two or more computing device operating in concert, in parallel, sequentially or the like; two or more computing devices may be included together in a single computing device or in two or more computing devices. An apparatus may interface or communicate with one or more additional devices as described below in further detail via a network interface device. Network interface device may be utilized for connecting an apparatus to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. An apparatus may include but is not limited to, for example, a computing device or cluster of computing devices in a first location and a second computing device or cluster of computing devices in a second location. An apparatus may include one or more computing devices dedicated to data storage, security, distribution of traffic for load balancing, and the like. An apparatus may distribute one or more computing tasks as described below across a plurality of computing devices of computing device, which may operate in parallel, in series, redundantly, or in any other manner used for distribution of tasks or memory between computing devices. An apparatus may be implemented, as a non-limiting example, using a “shared nothing” architecture.

Still referring to FIG. 1, an apparatus may be designed and/or configured to perform any method, method step, or sequence of method steps in any embodiment described in this disclosure, in any order and with any degree of repetition. For instance, an apparatus may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. An apparatus may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, an apparatus 100 may include a video capture device 104. A video capture device 104 may be configured to send class action data 128 to a computing device 108. A video capture device 104 may be configured to send class action data 128 to a processor 116. A video capture device 104 may be configured to send class action data 128 to a storage device 124.

Still referring to FIG. 1, as used herein, a “video capture device” is a device capable of recording audio, video, or both audio and video. A video capture device may include a video camera, webcam, cell phone camera, and the like. A video capture device may include a video storage device configured to save captured video and/or audio within video capture device, such as, without limitation, CDs, DVDs, blue-ray discs, SD card, MicroSD card, and the like. A video capture device may be configured to record video or audio of a physical space, such as a fitness studio. A video capture device may be configured to record video or audio of a virtual space, such as a virtual reality environment. A video capture device may be configured to record video or audio of a hybrid physical-virtual space, such as an augmented reality environment. A video capture device may be configured to transmit video, audio, or both video and audio data to a computing device. A video capture device may be configured to transmit data immediately after the data is captured (or, for example, after a short time which may be required for the video capture device to capture, process, and transmit the data). A video capture device may include one or more sensors such as, without limitation, a temperature sensor, a moisture sensor, and the like. A video capture device may transmit non-video, non-audio data, such as temperature or moisture data, to a computing device.

Still referring to FIG. 1, in some embodiments, video capture device 104 may include at least a camera. As used in this disclosure, a “camera” is a device that is configured to sense electromagnetic radiation, such as without limitation visible light, and generate an image representing the electromagnetic radiation. In some cases, a camera may include one or more optics. Exemplary non-limiting optics include spherical lenses, aspherical lenses, reflectors, polarizers, filters, windows, aperture stops, and the like. In some cases, at least a camera may include an image sensor. Exemplary non-limiting image sensors include digital image sensors, such as without limitation charge-coupled device (CCD) sensors and complimentary metal-oxide-semiconductor (CMOS) sensors, chemical image sensors, and analog image sensors, such as without limitation film. In some cases, a camera may be sensitive within a non-visible range of electromagnetic radiation, such as without limitation infrared. As used in this disclosure, “image data” is information representing at least a physical scene, space, and/or object. In some cases, image data may be generated by a camera. “Image data” may be used interchangeably through this disclosure with “image,” where image is used as a noun. An image may be optical, such as without limitation where at least an optic is used to generate an image of an object. An image may be material, such as without limitation when film is used to capture an image. An image may be digital, such as without limitation when represented as a bitmap. Alternatively, an image may be comprised of any media capable of representing a physical scene, space, and/or object. Alternatively, where “image” is used as a verb, in this disclosure, it may refer to generation and/or formation of an image.

Still referring to FIG. 1, an apparatus 100 may include a storage device 124. A storage device 124 may be configured to send class action data 128 to a computing device 108. A storage device 124 may be configured to send class action data 128 to a processor 116. A storage device may be configured to store or save data, such as class action data, class action data modifiers, and fitness class content, for later use.

Still referring to FIG. 1, in some embodiments, a video capture device sends data, such as class action data, to a storage device. In some embodiments, a computing device sends data, such as class action data, class action data modifiers, and fitness class content, to a storage device. In some embodiments, a computing device requests data, such as historical class action data, from a storage device. In some embodiments, a display requests data, such as historical class action data, from a storage device.

Still referring to FIG. 1, in a non-limiting example, video capture device 104 may include an augmented reality (AR) device. As used in this disclosure, an “augmented reality device” is a device that permits a user to view a typical field of vision of the user and superimposes digital information and/or graphic on the field of vision. AR device may include a view window. A “view window,” for the purpose of this disclosure, is a portion of the AR device that permits a user to observe a view of a field of vision; view window may include a transparent window, such as a transparent portion of goggles such as lenses or the like. Additionally, or alternatively, view window may include a screen that displays a field of vision to a user. In some embodiments, AR device may include a projection device, defined as a device that inserts an image into a field of vision. Where view window includes a screen, projection device may include a software and/or hardware component that adds an inserted graphic into a signal to be rendered on the screen. Projection device and/or view window may make use of reflective waveguides, diffractive waveguides, or the like to transmit, project, and/or display graphics. For instance, and without limitation, projection device may project images through and/or reflect images off an eyeglass-like structure and/or lens piece, where either both field of vision and images from projection device may be so displayed, or the former may be permitted to pass through a transparent surface. Projection device and/or view window may be incorporated in a contact lens or eye tap device, which may introduce images into light entering an eye to cause display of such images. Projection device and/or view window may display some images using a virtual retina display (VRD), which may display an image directly on a retina of a user.

With continued reference to FIG. 1, in some cases, AR device may be configured to receive a view feed. As used in this disclosure, a “view feed” refers to a real-time visual data obtained from AR device as the user navigates and interacts with the physical environment. In a non-limiting example, view feed may represent user's perspective and field of view. Capturing view feed may include capturing the surrounding environment, objects, any relevant spatial information, and/or the like of the user. In an embodiment, view feed may serve as a foundation for AR device, wherein view feed may provide visual data to align, anchor, or otherwise render digital content onto the user's view of the real world. In some cases, view feed may be utilized for various image processing, computer vision, and/or machine learning tasks, such as, without limitation, object recognition, spatial mapping, user's position and/or movement tracking, and/or the like described herein.

With continued reference to FIG. 1, AR device may be implemented in any suitable way, including without limitation incorporation of or in a head mounted display, a head-up display, a display incorporated in eyeglasses, googles, headsets, helmet display systems, or the like, a display incorporated in contact lenses, an eye tap display system including without limitation a laser eye tap device, VRD, or the like. Persons skilled in the art, upon reviewing the entirety of this disclosure, will be aware of various optical projection and/or display technologies that may be incorporated in AR device consistently with this disclosure.

With continued reference to FIG. 1, view window, projection device, and/or other display devices incorporated in AR device may implement a stereoscopic display. A “stereoscopic display,” as used in this disclosure, is a display that simulates a user experience of viewing a three-dimensional (3D) space and/or object, for instance by simulating and/or replicating different perspectives of a user's two eyes; this is in contrast to a two-dimensional image, in which images presented to each eye are substantially identical, such as may occur when viewing a flat screen display. Stereoscopic display may display two flat images having different perspectives, each to only one eye, which may simulate the appearance of an object or space as seen from the perspective of that eye. Alternatively, or additionally, stereoscopic display may include a three-dimensional display such as a holographic display or the like. Persons skilled in the art, upon reviewing the entirety of this disclosure, will be aware of various alternative or additional types of stereoscopic display that may be employed in AR device.

With continued reference to FIG. 1, AR device may include a field camera. A “field camera,” as used in this disclosure, is an optical device, or combination of optical devices, configured to capture a field of vision as an electrical signal, to form a digital image. Field camera may include a single camera and/or two or more cameras used to capture a field of vision; for instance, and without limitation, the two or more cameras may capture two or more perspectives for use in stereoscopic and/or three-dimensional display, as described above. Field camera may capture a feed including a plurality of frames, such as without limitation a video feed.

Still referring to FIG. 1, an apparatus may include a computing device 108. A computing device 108 may include at least a processor 116 and a memory 112 communicatively connected to the at least processor, the memory containing instructions configuring the at least processor to perform a process described herein. A computing device may include, for example, a computer or a smartphone. Computing devices are described in further detail herein.

Still referring to FIG. 1, a computing device 108 may be configured to receive class action data 128 from a video capture device 104. A computing device 108 may be configured to receive class action data 128 from a storage device 124. For example, a computing device may be communicatively connected to a video capture device, and a computing device may include at least a processor and a memory communicatively connected to the at least processor, the memory containing instructions configuring the at least processor to receive class action data from the video capture device.

Still referring to FIG. 1, as used herein, “class action data” is an audio or video element of a fitness class. Class action data may include data from ongoing classes and data from past classes. In some embodiments, fitness classes may include classes such as, without limitation, dance classes, ballroom dancing, Zumba, aerobics, circus techniques, gymnastics, Pilates, kettlebell workouts, circuit workouts, partner-based exercises, martial arts (including wrestling, boxing, jujutsu, judo, karate, kung fu, taekwondo, hapkido, silat, escrima, arnis, kali, boxing, muay thai, kickboxing, tai chi), and yoga (including various types of ashtanga, Iyengar, hot yoga, etc.). Class action data may include video, audio, or both of class participants, such as, without limitation, one or more instructors, instructor assistants, students, companions, and the like. Class action data may include video, audio, or both of, without limitation, class participant poses, motions, facial expressions, speech, and the like. In some embodiments, a computing device receives live class action data, such as data from an ongoing class. In some embodiments, a computing device receives historical class action data, such as data from a prerecorded training session of an instructor and a student.

Still referring to FIG. 1, a computing device 108 may be configured to analyze class action data 128 using an action module 132. For example, a computing device may be communicatively connected to a video capture device, and a computing device may include at least a processor and a memory communicatively connected to the at least processor, the memory containing instructions configuring the at least processor to analyze class action data using an action module.

Still referring to FIG. 1, as used herein, an “action module” is a is a software and/or hardware module configured to process or edit class action data. Action module may be implemented, without limitation, using combinational or sequential hardware logic, firmware, assembly code, and/or higher-level software instructions. For instance, and without limitation, action module may include video and/or audio codec hardware and/or software, at least a graphical processing unit (GPU), and/or one or more filters and/or other signal processing software and/or hardware. It is noted that while the term “module” is used herein, this term is not intended to require any particular configuration of the corresponding software and/or hardware code and/or configuration. For example, “module” should not be construed to mean that the software code is embodied in a discrete set of code and/or circuitry independent of code and/or circuitry used to implement other elements disclosed herein. Rather, the term “module” is used herein merely as a convenient way to refer to the underlying functionality.

Still referring to FIG. 1, processor may apply data compression techniques to class action data. “Data compression,” as used in this disclosure, is the process of encoding information using fewer bits than the original representation. Any particular compression is either lossy or lossless. Lossless compression reduces bits by identifying and eliminating statistical redundancy. No information is lost in lossless compression. Lossy compression reduces bits by removing unnecessary or less important information. In some embodiments, processor may utilize an encoder to perform data compression on class action data. class action data may be compressed in order to optimize speed and/or cost of transmission of class action data. For class action data including video, a processor may be configured to identify a series of frames of a video. The series of frames May include a group of pictures having some degree of internal similarity, such as a group of pictures representing a scene. In some embodiments, comparing series of frames may include video compression by inter-frame coding. The “inter” part of the term refers to the use of inter frame prediction. This kind of prediction tries to take advantage from temporal redundancy between neighboring frames enabling higher compression rates. Video data compression is the process of encoding information using fewer bits than the original representation. Data compression may be subject to a space-time complexity trade-off. For instance, a compression scheme for video may require expensive hardware for the video to be decompressed fast enough to be viewed as it is being decompressed, and the option to decompress the video in full before watching it may be inconvenient or require additional storage. Video data may be represented as a series of still image frames. Such data usually contains abundant amounts of spatial and temporal redundancy. Video compression algorithms attempt to reduce redundancy and store information more compactly.

Still referring to FIG. 1, inter-frame coding may function by comparing each frame in the video with another frame, which may include a previous frame. Individual frames of a video sequence may be compared between frames, and a video compression codec may send only the differences from a reference frame for frames other than the reference frame. If a frame contains areas where nothing has moved, a system may issue a short command that copies that part of a reference frame into the instant frame. If sections of a frame move in a manner describable through vector mathematics and/or affine transformations, or differences in color, brightness, tone, or the like, an encoder may emit a command that directs a decoder to shift, rotate, lighten, or darken a relevant portion. An encoder may also transmit a residual signal which describes remaining more subtle differences from reference frame, for instance by subtracting a predicted frame generated through vector motion commands from the reference frame pixel by pixel. Using entropy coding, these residual signals may have a more compact representation than a full signal. In areas of video with more motion, compression may encode more data to keep up with a larger number of pixels that are changing. As used in this disclosure, reference frames are frames of a compressed video (a complete picture) that are used to define future frames. As such, they are only used in inter-frame compression techniques. Some modern video encoding standards, such as H.264/AVC, allow the use of multiple reference frames. This may allow a video encoder to choose among more than one previously decoded frame on which to base each macroblock in another frame.

Still referring to FIG. 1, two frame types used in inter-fame coding may include P-frames and B-frames. A P-frame (Predicted picture) may hold only changes in an image from a reference frame. For example, in a scene where a car moves across a stationary background, only the car's movements may need to be encoded; an encoder does not need to store the unchanging background pixels in the P-frame, thus saving space. A B-frame (Bidirectional predicted picture) may save even more space by using differences between a current frame and both preceding and following frames to specify its content. An inter coded frame may be divided into blocks known as macroblocks. A macroblock may include a processing unit in image and video compression formats based on linear block transforms, such as without limitation a discrete cosine transform (DCT). A macroblock may consist of 16×16 samples, for instance as measured in pixels, and may be further subdivided into transform blocks, and may be further subdivided into prediction blocks. Formats which are based on macroblocks may include JPEG, where they are called MCU blocks, H.261, MPEG-1 Part 2, H.262/MPEG-2 Part 2, H.263, MPEG-4 Part 2, and H.264/MPEG-4 AVC. After an inter coded frame is divided into macroblocks, instead of and/or in addition to directly encoding raw pixel values for each block, an encoder may identify a block similar to the one it is encoding on another frame, referred to as a reference frame. This process may be performed by a block matching algorithm. If an encoder succeeds in its search for a reference frame, a block may be encoded by a vector, known as motion vector, which points to a position of a matching block at the reference frame. A process of motion vector determination may be referred to as motion estimation. Residual values, based on differences between estimated blocks and blocks they are meant to estimate, may be referred to as a prediction error and may be transformed and sent to a decoder.

Still referring to FIG. 1, using a motion vector pointing to a matched block and/or a prediction error, a decoder may reconstruct raw pixels of an encoded block without requiring transmission of the full set of pixels. For example, a video may be compressed using a P-frame algorithm and broken down into macroblocks. Individual still images taken from a video may then be compared against a reference frame taken from another a video or augmented video. A P-frame from a video may only hold the changes in image from target a video. For example, if both a video include a similar, then what may be encoded and stored may include subtle changes such as an additional character dialogue or character appearances compared to the video without the dialogue. Exemplary video compression codecs may include without limitation H.26x codecs, MPEG formats, VVC, SVT-AV1, and the like. In some cases, compression may be lossy, in which some information may be lost during compression. Alternatively, or additionally, in some cases, compression may be substantially lossless, where substantially no information is lost during compression. In some cases, image component may include a plurality of temporally sequential frames. In some cases, each frame may be encoded (e.g., bitmap or vector-based encoding). In some embodiments, a classifier may receive an input from a processor including a video encoder. In a non-limiting example, a processor may select a reference frame to be encoded and may transmit the reference frame to a classifier; such a classifier may include a classifier configured to categorize images based on a pose being performed in an image, as described below. In some embodiments, categorizing reference frames using a classifier may allow for a video frame, or a section of a video represented by a frame, to be categorized. Each frame may be configured to be displayed by way of a display. Exemplary displays include without limitation light emitting diode (LED) displays, cathode ray tube (CRT) displays, liquid crystal displays (LCDs), organic LEDs (OLDs), quantum dot displays, projectors (e.g., scanned light projectors), and the like.

Still referring to FIG. 1, in some embodiments, processor may perform a plurality of digital processing techniques such as acquisition, image enhancement, image restoration, color image processing, data augmentation, wavelets and multi-resolution processing, image compression, morphological processing, representation and description, object and recognition, and the like. In some embodiments, processing class action data includes utilizing feature extraction. Feature extraction is a part of computer vision, in which, an initial set of the raw data is divided and reduced to more manageable groups. “Features,” as used in this disclosure, are parts or patterns of an object in an image that help to identify it. For example—a square has 4 corners and 4 edges, they can be called features of the square. Features may include properties like corners, edges, regions of interest points, ridges, etc. In some embodiments, processing class action data may include segmenting an image of the class action data utilizing image segmentation. “Image segmentation,” as used in this disclosure, is a sub-domain of computer vision and digital image processing, as described further below, which aims at grouping similar regions or segments of an image under their respective class labels.

Still referring to FIG. 1, a processor may use interpolation and/or upsampling methods to process class action data. For instance, processor may convert a low pixel count image into a desired number of pixels. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a low pixel count image to a desired number of pixels. In some instances, a set of interpolation rules may be trained by sets of highly detailed images and images that may have been downsampled to smaller numbers of pixels, and a neural network or other machine learning model that is trained using the training sets of highly detailed images to predict interpolated pixel values in a facial picture context. As a non-limiting example, a sample picture with sample-expanded pixels (e.g., pixels added between the original pixels) may be input to a neural network or machine-learning model and output a pseudo replica sample-picture with dummy values assigned to pixels between the original pixels based on a set of interpolation rules. In some instances, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. I.e., you run the picture with sample-expanded pixels (the ones added between the original pixels, with dummy values) through this neural network or model and it fills in values to replace the dummy values based on the rules.

Still referring to FIG. 1, processor may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. In some embodiments, processor may use luma or chroma averaging to fill in pixels in between original image pixels. Processor may down-sample class action data to a desired lower number of pixels. As a non-limiting example, a high pixel count image may have 256 pixels, however a desired number of pixels may be 128. Processor may down-sample the high pixel count image to convert the 256 pixels into 128 pixels.

Still referring to FIG. 1, in some embodiments, processor may be configured to perform downsampling on data such as without limitation class action data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Still referring to FIG. 1, processor may classify class action data to a plurality of categories, such as poses or movements, using a machine-learning model such as a classifier. A classifier may include a machine-learning model, such as a mathematical model, neural net, or program generated by a machine learning algorithm known as a “classification algorithm,” that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. For example, a classifier may receive a plurality of class action data and output a datum that can be used to categorize the class action data into bins, such as categories, such as poses or movements. Processor may generate a classifier using a classification algorithm, which may include a process whereby a processor derives a classifier from training data. Training data may include images of individuals performing poses, tagged with the poses they are performing. In some embodiments, a classifier may be applied to frames from a video, in order to categorize that frame and/or a section of the video represented by that frame. In some embodiments, a classifier may receive an input from a processor including a video encoder, as described above. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 1, classification may include particular image requirements. In some instances, image requirements may include resolution, pixel count, and the like. Classification may include, without limitation, matching class action data to one or more requirements. Image classifier may be trained, without limitation, using training data containing images of a type to be matched, such as images of; thus image classifier may be trained to detect whether an object class depicted in a given image matches an object class depicted in a stored image, or otherwise match a subject of an image to a subject of another image.

Still referring to FIG. 1, in some embodiments, image pixel count may be modified based on the input requirements of a machine learning model, such as an image classifier. For example, an image classifier may have a number of inputs into which pixels are input, and thus may require either increasing or decreasing the number of pixels in an image to be input and/or used for training image classifier. In some embodiments, interpolation, upsampling, sample expander, low pass filter, and/or downsampling may be used to modify pixel count to a required number of pixels for an image classifier.

Still referring to FIG. 1, an action module may utilize a computer vision model, such as a computer vision model configured to detect specific poses via image processing, image recognition, motion capture, and the like. A computer vision model may be configured to translate visual data within class action data based on features and contextual information. Features and contextual information may be identified manually by a professional such as an instructor during model training.

Still referring to FIG. 1, in some cases, user/instructor/third-party avatar may be registered, by processor 116, to a view feed using computer vision model. For the purposes of this disclosure, an “user avatar” is a virtual avatar of a user. In another embodiment, the AR device may display a third-party avatar to the user. For the purposes of this disclosure, an “third-party avatar” is a virtual avatar of a third party. For the purposes of this disclosure, “third party” is a person taking a fitness class other than a user that is taking the fitness class. In another embodiment, the AR device may display an instructor avatar to the user. For the purposes of this disclosure, an “instructor avatar” is a virtual avatar of an instructor. A “virtual avatar” as used in this disclosure is any digital creation displayed through a screen. Digital creations may include, but are not limited to, digital entities, virtual objects, and the like. The virtual avatar may be a visual representation of a user, an instructor, and/or a third party. The virtual avatar may include, without limitation, two-dimensional representations of animals and/or human characters, three-dimensional representations of animals and/or human characters, and the like. For instance and without limitation, the virtual avatar may include penguins, wolves, tigers, frogs, young human characters, old human characters, middle-aged human characters, and the like. In some embodiments, the virtual avatar may include clothing, apparel, and/or other items. Clothing may include, but is not limited to, jackets, pants, shirts, shorts, suits, ties, and the like. Apparel may include, but is not limited to, skis, ski goggles, baseball mitts, tennis rackets, suitcases, and the like. The virtual avatar may be generated as a function of user image data and/or instructor image data. For instance, and without limitation, processor 116 may generate a user avatar that corresponds to a user. For instance and without limitation, the processor 116 may generate a third-party avatar that corresponds to a third party. For instance, and without limitation, the processor 116 may generate an instructor avatar that corresponds to an instructor.

Still referring to FIG. 1, as used herein, “registration” of an avatar or any other visual elements to a view feed means identifying a location within the view feed of each pixel of each visual element or virtual avatar. Registration may be done with respect to a field coordinate system. As used herein, a “field coordinate system,” is a coordinate system of a view feed, such as a Cartesian coordinate system a polar coordinate system, or the like. Registration of a frame to a view feed may be characterized as a map associating each pixel of a frame, and/or coordinates thereof in a frame coordinate system, to a pixel of field coordinate system. Such mapping may result in a two-dimensional projection of corresponding three-dimensional coordinates on one or more two-dimensional images. For example, registration of a 2D visual element may be done by identifying a region of a field coordinate system that matches the dimensions of the visual element and displaying the visual element in that region (such as when a visual element is intended to be displayed relative to a user's field of view regardless of user movement). As another example, registration of a 3D element may be done by rendering the 3D element as voxels, taking a projection of the voxels on the field coordinate system, and displaying the projection (such as when display of a 3D visual element is desired). As another example, registration of an avatar or a visual element may be done by rendering the avatar or the visual element in a location relative to an object, taking a projection of the avatar on a field coordinate system, and displaying the projection (such as when rendering text describing instructions to an example yoga pose beside the virtual avatar iteratively performing the example yoga pose is desired). In some embodiments, registration of an avatar or a visual element may change from frame to frame. For example, if display of a rotating 3D visual element is desired, then a projection of the avatar or the visual element may differ from frame to frame, such as due to a change in the perspective of a user relative to the rotating element. As another example, display of an avatar or a visual element may change if the avatar or the visual element is displayed relative to an object, and a user/user avatar moves relative to the object.

Still referring to FIG. 1, alternatively or additionally, an action module may include a machine vision system. A machine vision system may use images from a camera, such as a camera included in a video capture device, to make a determination about a scene, space, and/or object. For example, in some cases a machine vision system may be used for world modeling or registration of objects within a space. In some cases, registration may include image processing, such as without limitation object recognition, feature detection, edge/corner detection, and the like. Non-limiting example of feature detection may include scale invariant feature transform (SIFT), Canny edge detection, Shi Tomasi corner detection, and the like. In some cases, registration may include one or more transformations to orient a camera frame (or an image or video stream) relative a three-dimensional coordinate system; exemplary transformations include without limitation homography transforms and affine transforms. In an embodiment, registration of first frame to a coordinate system may be verified and/or corrected using object identification and/or computer vision, as described above. For instance, and without limitation, an initial registration to two dimensions, represented for instance as registration to the x and y coordinates, may be performed using a two-dimensional projection of points in three dimensions onto a first frame, however. A third dimension of registration, representing depth and/or a z axis, may be detected by comparison of two frames; for instance, where first frame includes a pair of frames captured using a pair of cameras (e.g., stereoscopic camera also referred to in this disclosure as stereo-camera), image recognition and/or edge detection software may be used to detect a pair of stereoscopic views of images of an object; two stereoscopic views may be compared to derive z-axis values of points on object permitting, for instance, derivation of further z-axis points within and/or around the object using interpolation. This may be repeated with multiple objects in field of view, including without limitation environmental features of interest identified by object classifier and/or indicated by an operator. In an embodiment, x and y axes may be chosen to span a plane common to two cameras used for stereoscopic image capturing and/or an xy plane of a first frame; a result, x and y translational components and ¢ may be pre-populated in translational and rotational matrices, for affine transformation of coordinates of object, also as described above. Initial x and y coordinates and/or guesses at transformational matrices may alternatively or additionally be performed between first frame and second frame, as described above. For each point of a plurality of points on object and/or edge and/or edges of object as described above, x and y coordinates of a first stereoscopic frame may be populated, with an initial estimate of z coordinates based, for instance, on assumptions about object, such as an assumption that ground is substantially parallel to an xy plane as selected above. Z coordinates, and/or x, y, and z coordinates, registered using image capturing and/or object identification processes as described above may then be compared to coordinates predicted using initial guess at transformation matrices; an error function may be computed using by comparing the two sets of points, and new x, y, and/or z coordinates, may be iteratively estimated and compared until the error function drops below a threshold level. In some cases, a machine vision system may use a classifier, such as any classifier described throughout this disclosure.

Still referring to FIG. 1, a machine vision system may utilize a machine vision camera, or data from a machine vision camera. A video capture device may include a machine vision camera. An exemplary machine vision camera that may be included in an apparatus is an OpenMV Cam H7 from OpenMV, LLC of Atlanta, Georgia, U.S.A. OpenMV Cam includes a small, low power, microcontroller which allows execution of machine vision applications. OpenMV Cam comprises an ARM Cortex M7 processor and a 640×480 image sensor operating at a frame rate up to 150 fps. OpenMV Cam may be programmed with Python using a Remote Python/Procedure Call (RPC) library. OpenMV CAM may be used to operate image classification and segmentation models, such as without limitation by way of TensorFlow Lite; detection motion, for example by way of frame differencing algorithms; marker detection, for example blob detection; object detection, for example face detection; eye tracking; person detection, for example by way of a trained machine learning model; camera motion detection, for example by way of optical flow detection; code (barcode) detection and decoding; image capture; and video recording.

Still referring to FIG. 1, a camera may be a stereo-camera. As used in this disclosure, a “stereo-camera” is a camera that senses two or more images from two or more vantages. As used in this disclosure, a “vantage” is a location of a camera relative a scene, space and/or object which the camera is configured to sense. In some cases, a stereo-camera may determine depth of an object in a scene as a function of parallax. As used in this disclosure, “parallax” is a difference in perceived location of a corresponding object in two or more images. An exemplary stereo-camera is TaraXL from e-con Systems, Inc of San Jose, California. TaraXL is a USB 3.0 stereo-camera which is optimized for NVIDIA® Jetson AGX Xavier™/Jetson™ TX2 and NVIDIA GPU Cards. TaraXL's accelerated Software Development Kit (TaraXL SDK) is capable of doing high quality 3D depth mapping of WVGA at a rate of up to 60 frames per second. TaraXL is based on MT9V024 stereo sensor from ON Semiconductor. Additionally, TaraXL includes a global shutter, houses 6 inertial measurement units (IMUs), and allows mounting of optics by way of an S-mount lens holder. TaraXL may operate at depth ranges of about 50 cm to about 300 cm.

Still referring to FIG. 1, an action module may include one or more machine-learning models such as, without limitation, an artificial neural network (ANN), a convolution neural network (CNN), and the like. For example, and without limitation, an action module may receive class action data containing a video as input. A computing device may train one or more models using pose training data containing a plurality of pose vectors (i.e., an array of user joint locations in the frame image) as input corresponding to a plurality of poses as output. A computing device may then apply the trained model to class action data as a pose regressor. One or more models may output a pose identifier with maximum possibility as a function of class action data. A machine learning model may include a classifier. A machine learning model may be trained using a dataset of historical class action data, tagged data categories; such a language model may accept class action data as an input, and categorize it as an output. For example, a language model may include a classifier trained using historical class action data tagged with the pose an instructor takes; such a classifier may accept class action data as an input and may, as an output, categorize the class action data according to the pose an instructor takes. A machine learning model may be trained to recognize poses or movements using historical image or video data, tagged with the pose or movement the subject of the photo or video is performing; such a machine learning model may accept as an input image or video class action data (for example, video or image class action data captured using a video capture device), and may categorize the image or video class action data as an output. In this way, a machine learning model may detect whether certain events (such as an instruction to perform a pose) are taking place in a class based on image or video class action data.

Still referring to FIG. 1, an action module may include a language model configured to detect keywords, phrases, sentences, and the like. As used herein, a “language model” is a program capable of interpreting or producing natural language. A language model may include a machine learning model configured to recognize or interpret audio speech. A language model may include a neural network. A language model may be trained using a dataset that includes natural language. A language model may be trained using a dataset that includes historical class action data. A language model may include a classifier. A language model may be trained using a dataset of historical audio elements of class action data, tagged with categories of speech; such a language model may accept an audio element of class action data as an input, and categorize it as an output. For example, a language model may include a classifier trained using historical audio class action data tagged with whether an instructor's description of a pose is too complex; such a classifier may accept audio class action data as an input and may, as an output, categorize the audio class action data according to whether it is too complex. As another example, a language model may be trained using a dataset including spoken words and/or phrases, tagged with associated events (such as an instruction to perform a pose, or an instruction to take a break); such a language model may accept audio class action data as an input and may categorize the audio class action data according to whether it includes keywords or phrases associated with certain events as an output. In this way, a language model may detect whether certain events (such as an instruction to perform a pose) are taking place in a class using audio class action data.

Still referring to FIG. 1, in some embodiments, analyzing class action data may include matching class action data to class content. For example, and without limitation, a computing device may be configured to link certain image and/or video clips to certain class content such as a pose and/or instructions to the pose.

Still referring to FIG. 1, in some embodiments, analyzing class action data may include fragmenting class action data. For example, a computing device may be configured to break a recorded training session into modular sections that can be categorized (such as via a classifier) and/or rearranged for further processing steps described below. In some embodiments, class action data may be fragmented based on a change in categorization a machine learning model. In some embodiments, class action data may be fragmented based on class participant (such as instructor) input.

Still referring to FIG. 1, a computing device 108 may be configured to determine a class action data modifier 136 based on an analysis of class action data 128. A class action data modifier 136 may be determined using an action module 132. For example, a computing device may be communicatively connected to a video capture device, and a computing device may include at least a processor and a memory communicatively connected to the at least processor, the memory containing instructions configuring the at least processor to determine a class action data modifier based on an analysis of class action data.

Still referring to FIG. 1, as used herein, a “class action data modifier” is an element of data related to a change in class action data. A class action data modifier may indicate that a modification in fitness class content is needed. For example, a class action data modifier may indicate that additional guidance as to how to perform a pose is necessary. As another example, a class action data modifier may indicate that a pre-planned video or audio segment should be replaced by an alternate element of fitness class content, such as an element of fitness class content that provides additional guidance as to how to perform a pose. As another example, a class action data modifier may indicate that an element of fitness class content, such as one that provides additional guidance, should be inserted between pre-planned video or audio segments. As another example, a class action data modifier may indicate that a historical tutorial video should be displayed in a picture in picture format.

Still referring to FIG. 1, a class action data modifier may be determined based on categorization of class action data, such as categorization by a machine learning model. For example, if a machine learning model categorizes class action data as data associated with an instruction to perform a pose, then a class action data modifier for displaying an instructional video on performing that pose may be determined.

Still referring to FIG. 1, as another example, and without limitation, a class action data modifier may include language guidance, such as a warning to an instructor that their description is too complicated. Language guidance may use the output of a language model described above. In an embodiment, class action data is input into a language model and the language model outputs an interpretation of speech included in the class action data (for example, a language model may output a text transcript of an instructor's speech). Such an output may be used to determine the statistical prevalence of a word or phrase used by a class participant, such as an instructor. Low statistical prevalence may be associated with difficult to understand instruction. For example, if an instructor uses a low statistical prevalence word, then the instructor may be notified that the word is complex and may not be understood. In some embodiments, an apparatus identifies a higher statistical prevalence word or phrase to use to substitute a low statistical prevalence word or phrase. In a non-limiting example, if an instructor uses a low statistical prevalence word or phrase, an apparatus may identify a higher statistical prevalence word or phrase that has the same meaning or a similar meaning and may display to the instructor a suggestion to use the higher statistical prevalence word or phrase. In some embodiments, an apparatus identifies a lower statistical prevalence word or phrase to use to substitute a high statistical prevalence word or phrase, such as if higher variety is desired. In a non-limiting example, if an instructor uses a high statistical prevalence word or phrase, an apparatus may identify a lower statistical prevalence word or phrase that has the same meaning or a similar meaning and may display to the instructor a suggestion to use the lower statistical prevalence word or phrase. In some embodiments, an apparatus may identify an alternative word or phrase, such as a higher or lower prevalence word or phrase and may determine a class action data modifier as a function of the alternative word or phrase.

With continued reference to FIG. 1, in one or more embodiments, processor 116 may implement one or more aspects of “generative artificial intelligence (AI),” a type of AI that uses machine learning algorithms to create, establish, or otherwise generate data such as, without limitation, classroom data, instructor feedback, and/or the like in any data structure described herein (e.g., text, image, video, audio, among others) that is similar to one or more provided sets of training data. In an embodiment, action module described herein may include one or more generative machine learning models that are trained on one or more set of examples. One or more generative machine learning models may be configured to generate new examples that are similar to the training data of the one or more generative machine learning models but are not exact replicas; for instance, and without limitation, data quality or attributes of the generated examples may bear a resemblance to the training data provided to one or more generative machine learning models, wherein the resemblance may pertain to underlying patterns, features, or structures found within the provided training data.

Still referring to FIG. 1, in some cases, generative machine learning models may include one or more generative models. As described herein, “generative models” refers to statistical models of the joint probability distribution P(X, Y) on a given observable variable x, representing features or data that can be directly measured or observed (e.g., video clips or images of user's poses and movements, sensor readings from wearable devices and/or plurality of sensors, time-series data representing sequence of poses or transitions, audio recordings of user's breathing patterns or verbal responses, and/or the like) and target variable y, representing the outcomes or labels that one or more generative models aims to predict or generate (e.g., instructor feedback, corrective instructions, guidance, error flags or annotations, supplementary content, and/or the like). In some cases, generative models may rely on Bayes theorem to find joint probability; for instance, and without limitation, Naïve Bayes classifiers may be employed by processor 116 to categorize input data such as, without limitation, yoga poses into different classes such as, without limitation, difficulty levels based on observable features described herein.

In a non-limiting example, and still referring to FIG. 1, one or more generative machine learning models may include one or more Naïve Bayes classifiers generated, by processor 116, using a Naïve bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)=P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device 104 may then calculate a likelihood table by calculating probabilities of different data entries and classification labels. Computing device 104 may utilize a naïve Bayes equation to calculate a posterior probability for each class. A class containing the highest posterior probability is the outcome of prediction.

Still referring to FIG. 1, although Naïve Bayes classifier may be primarily known as a probabilistic classification algorithm; however, it may also be used as a generative model described herein due to its capability of modeling the joint probability distribution P(X, Y) over observable variables X and target variable Y. In an embodiment, Naïve Bayes classifier may be configured to make an assumption that the features X are conditionally independent given class label Y, allowing generative model to estimate the joint distribution as P(X, Y)=P(Y)ΠiP(Xi|Y), wherein P(Y) may be the prior probability of the class, and P(Xᵢ|Y) is the conditional probability of each feature given the class. One or more generative machine learning models containing Naïve Bayes classifiers may be trained on labeled training data, estimating conditional probabilities P(Xᵢ|Y) and prior probabilities P(Y) for each class; for instance, and without limitation, using techniques such as Maximum Likelihood Estimation (MLE). One or more generative machine learning models containing Naïve Bayes classifiers may select a class label y according to prior distribution P(Y), and for each feature Xᵢ, sample at least a value according to conditional distribution P(Xᵢ|y). Sampled feature values may then be combined to form one or more new data instance with selected class label y. In a non-limiting example, one or more generative machine learning models may include one or more Naïve Bayes classifiers to generate new examples of yoga poses based on difficulty levels (e.g., beginner, intermediate, advanced), wherein the models may be trained using training data containing a plurality of features e.g., body alignment, balance, pose complexity, and/or the like as input correlated to a plurality of labeled classes e.g., difficulty levels as output.

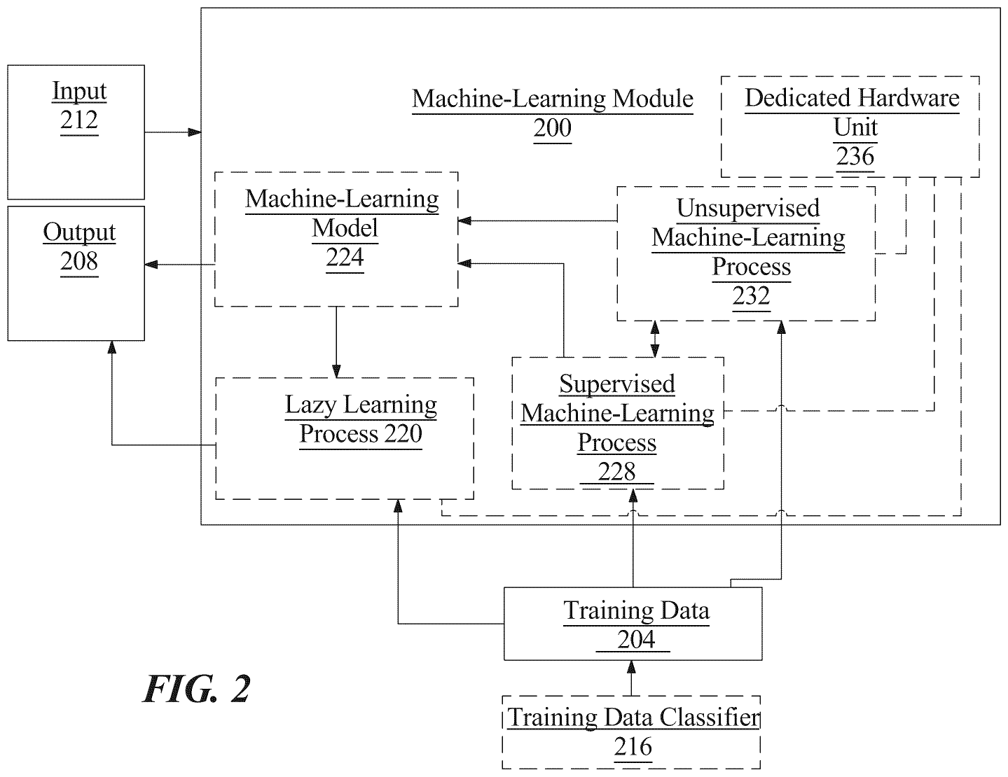

Still referring to FIG. 1, in some cases, one or more generative machine learning models may include generative adversarial network (GAN). As used in this disclosure, a “generative adversarial network” is a type of artificial neural network with at least two sub models (e.g., neural networks), a generator, and a discriminator, that compete against each other in a process that ultimately results in the generator learning to generate new data samples, wherein the “generator” is a component of the GAN that learns to create hypothetical data by incorporating feedbacks from the “discriminator” configured to distinguish real data from the hypothetical data. In some cases, generator may learn to make discriminator classify its output as real. In an embodiment, discriminator may include a supervised machine learning model while generator may include an unsupervised machine learning model as described in further detail with reference to FIG. 2.

With continued reference to FIG. 1, in an embodiment, discriminator may include one or more discriminative models, i.e., models of conditional probability P(Y|X=x) of target variable Y, given observed variable X. In an embodiment, discriminative models may learn boundaries between classes or labels in given training data. In a non-limiting example, discriminator may include one or more classifiers as described in further detail below with reference to FIG. 2 to distinguish between different categories e.g., real vs. fake, or states e.g., TRUE vs. FALSE within the context of generated data such as, without limitations, yoga poses, yoga instructions, and/or the like. In some cases, processor 116 may implement one or more classification algorithms such as, without limitation, Support Vector Machines (SVM), Logistic Regression, Decision Trees, and/or the like to define decision boundaries.

In a non-limiting example, and still referring to FIG. 1, generator of GAN may be responsible for creating synthetic data that resembles real yoga instruction content. In some cases, GAN may be configured to receive class action data such as, without limitation, one or more video clips of one or more users, as input and generates corresponding instruction texts or even supplementary videos containing information describing or evaluating the performance of one or more poses shown in each of the received video clips. On the other hand, discriminator of GAN may evaluate the authenticity of the generated content by comparing it to real yoga instruction data, for example, discriminator may distinguish between genuine and generated content and providing feedback to generator to improve the model performance.

With continued reference to FIG. 1, in other embodiments, one or more generative models may also include a variational autoencoder (VAE). As used in this disclosure, a “variational autoencoder” is an autoencoder (i.e., an artificial neural network architecture) whose encoding distribution is regularized during the model training process in order to ensure that its latent space includes desired properties allowing new data sample generation. In an embodiment, VAE may include a prior and noise distribution respectively, trained using expectation-maximization meta-algorithms such as, without limitation, probabilistic PCA, sparse coding, among others. In a non-limiting example, VEA may use a neural network as an amortized approach to jointly optimize across input data and output a plurality of parameters for corresponding variational distribution as it maps from a known input space to a low-dimensional latent space. Additionally, or alternatively, VAE may include a second neural network, for example, and without limitation, a decoder, wherein the “decoder” is configured to map from the latent space to the input space.

In a non-limiting example, and still referring to FIG. 1, VAE may be used by processor 116 to model complex relationships between class action data e.g., different poses, movements, and alignments. In some cases, VAE may encode input data into a latent space, capturing essential characteristics of user's poses and movements. Such encoding process may include learning one or more probabilistic mappings from observed class action data to a lower-dimensional latent representation. Latent representation may then be decoded back into the original data space, therefore reconstructing the observed user actions. In some cases, such decoding process may allow VAE to generate new examples or variations that are consistent with the learned distributions.

With continued reference to FIG. 1, in some embodiments, one or more generative machine learning models may be trained on a plurality of video clips of users performing various poses and actions as described herein, wherein the plurality of video clips may provide visual information that generative machine learning models analyze to understand the dynamics of yoga movements. In other embodiments, training data may also include voice-over instructions and feedback from instructors. In some cases, such data may help generative machine learning models to learn appropriate language and tone for providing instructions/guidance on various yoga poses and/or movements. Additionally, or alternatively, one or more generative machine learning models may utilize one or more predefined templates representing, for example, and without limitation, correct yoga poses. In a non-limiting example, one or more movement templates (i.e., predefined models or representations of correct and ideal physical movements, poses, or actions associated with specific yoga practices) may serve as benchmarks for comparing and evaluating plurality of video clips containing user's movement.

Still referring to FIG. 1, processor 116 may configure generative machine learning models to analyze input data such as, without limitation, video clips or other class action data and compare input data to one or more predefined templates such as movement templates representing correct yoga poses described above, thereby allowing processor 116 to identify discrepancies or deviations from the ideal form. In some cases, processor 116 may be configured to pinpoint specific errors in alignment, posture, balance, timing, or any other aspects of the user action. In a non-limiting example, processor 116 may be configured to implement generative machine learning models to incorporate additional models to detect a misaligned spine, an incorrect angle of a joint, or an improper transition between a first pose and a second pose. In some cases, errors may be classified into different categories or severity levels. In a non-limiting example, some errors may be considered minor, and generative machine learning model such as, without limitation, GAN may be configured to generate instructions contain only slight adjustments while others may be more significant and demand more substantial corrections. In some embodiments, processor 116 may be configured to flag or highlight poses that are performed incorrectly, altering the instructor or user to areas that need attention, directly on the video clip using one or more generative machine learning models described herein. In some cases, one or more generative machine learning models may be configured to generate and output indicators such as, without limitation, visual indicator, audio indicator, and/or any other indicators as described above. Such indicators may be used to signal the detected error described herein.

With continued reference to FIG. 1, in a non-limiting example, processor 116 may be configured to handle a group setting, for example, and without limitation, a yoga class may include a plurality of participants (i.e., users). In such embodiment, processor 116 may be configured to detect, using computer vision model described above, commonalities of deficiencies (i.e., errors) in movements among plurality of users, as compared to predefined “ideal” movements or poses (i.e., movement template). Computer vision model and/or one or more machine learning models described herein may be configured to perform pose detection, and analyze alignment, balance, and other key aspects of each detected pose. In some cases, one or more skeletal representations, each corresponding to each individual user of plurality of users, may be formed using computer vision model by connecting a plurality of points based on anatomical structure identified based on visual data such as, without limitation, a video clip of a group session. Computer vision model may use pairwise relations and graph algorithms to determine connections based on known relationships between joints e.g., knee connected to hip to construct a coherent skeleton. In some cases, processor 116 may be configured to identify and rank detected common deficiencies across plurality of users; for instance, and without limitation, one or more machine learning models may classify errors in a specific order e.g., a descending order of commonality. Such ranking process may enable a prioritization of most prevalent issues, allowing instructors or processor 116 to address the widespread challenges first. In a non-limiting example, if 80% of participants are struggling with a specific alignment in a particular pose, that issue may be detected and targeted with corrective instructions or demonstrations generated by one or more generative machine learning models.

Still referring to FIG. 1, in some cases, one or more generative machine learning models may also be applied by processor 116 to edit, modify, or otherwise manipulate existing data or data structures. In an embodiment, output of training data used to train one or more generative machine learning models such as GAN as described herein may include textual instructions or supplementary videos that linguistically or visually demonstrate modified class action data e.g., guidance to adjust specific body parts, corrected alignment or execution of the pose, and/or the like. In some cases, supplementary videos may be synchronized with the user's performance, for example, and without limitation, in a side-by-side or even overlayed arrangement with the input class action data, providing real-time visual guidance. Additionally, or alternatively, voice-over guidance may be generated using generative machine learning models to verbally guide users through the corrections. In some cases, such auditory feedback may be integrated with the supplementary videos, offering user a multisensory instructional experience.

Additionally, or alternatively, and still referring to FIG. 1, processor 116 may be configured to continuously monitor class action data. In an embodiment, processor 116 may configure discriminator to provide ongoing feedback and further corrections as needed to subsequent input data (e.g., video clips or other data related to user's movements and poses during a yoga session). In some cases, one or more sensors such as, without limitation, wearable device, motion sensor, or other sensors or devices described herein may provide additional class action data that may be used as subsequent input data or training data for one or more generative machine learning models described herein. An iterative feedback loop may be created as processor 116 continuously receive real-time data, identify errors as a function of real-time data, delivering corrections based on the identified errors, and monitoring user responses on the delivered corrections. In an embodiment, processor 116 may be configured to retrain one or more generative machine learning models based on user responses or update training data of one or more generative machine learning models by integrating user response into the original training data. In such embodiment, iterative feedback loop may allow machine learning module to adapt to the user's needs and performance, enabling one or more generative machine learning models described herein to learn and update based on user responses and generated feedback.

With continued reference to FIG. 1, other exemplary embodiments of generative machine learning models may include, without limitation, long short-term memory networks (LSTMs), (generative pre-trained) transformer (GPT) models, mixture density networks (MDN), and/or the like. As an ordinary person skilled in the art, upon reviewing the entirety of this disclosure, will be aware of various generative machine learning models may be used to generate and/or modify class action data, class data, instructor feedback, and/or any other data described herein.

Still referring to FIG. 1, in a further non-limiting embodiment, machine learning module may be further configured to generate a multi-model neural network that combines various neural network architectures described herein. In a non-limiting example, multi-model neural network may combine LSTM for time-series analysis with GPT models for natural language processing. Such fusion may be applied by processor 116 to generate real-time instructor feedback in yoga class setting. In some cases, multi-model neural network may also include a hierarchical multi-model neural network, wherein the hierarchical multi-model neural network may involve a plurality of layers of integration; for instance, and without limitation, different models may be combined at various stages of the network. Convolutional neural network (CNN) may be used for image feature extraction, followed by LSTMs for sequential pattern recognition, and a MDN at the end for probabilistic modeling. Other exemplary embodiments of multi-model neural network may include, without limitation, ensemble-based multi-model neural network, cross-modal fusion, adaptive multi-model network, among others. As an ordinary person skilled in the art, upon reviewing the entirety of this disclosure, will be aware of various generative machine learning models may be used to generate and/or modify class action data, class data, instructor feedback, and/or any other data described herein. As an ordinary person skilled in the art, upon reviewing the entirety of this disclosure, will be aware of various multi-model neural network and combination thereof that may be implemented by apparatus 100 in consistent with this disclosure.

Still referring to FIG. 1, in some embodiments, a fuzzy inferencing system may be used to measure how difficult instruction is to understand. For example, a fuzzy inferencing system may use as inputs the difficulty of a movement, the degree of difficulty of understanding the movement visually, and the statistical prevalence of a word or phrase used in the instruction and may output a measure of how difficult instruction is to understand. A fuzzy inferencing system may use as training data language associated with statistical prevalence ratings, categorized poses associated with difficulty ratings, and/or instructional videos with difficulty of understanding a pose ratings.

Still referring to FIG. 1, in some embodiments, a class action data modifier may be suggested by a computing device, and a professional or class participant may have the option as to whether to utilize the class action data modifier to generate fitness class content. For example, a computing device may create an alert on a class participant's smartphone, and class participant May use a visual interface to direct the computing device to utilize the class action data modifier to generate fitness class content.

Still referring to FIG. 1, a computing device may be configured to generate fitness class content as a function of a class action data modifier. For example, a computing device may be communicatively connected to a video capture device, and a computing device may include at least a processor and a memory communicatively connected to the at least processor, the memory containing instructions configuring the at least processor to generate fitness class content as a function of a class action data modifier.

Still referring to FIG. 1, as used herein, “fitness class content” is audio or video that has been edited. For example, fitness class content may include audio or video containing two or more elements of class action data that do not form a single continuous video or audio recording from a single perspective (such as due to being edited together). Generating fitness class content may include rearranging fragmented class action data as described above. For example, computing device may be configured to order, remove, or otherwise rearrange modular sections of a recorded training session.

Still referring to FIG. 1, generating fitness class content may include utilizing an action module, as described above. For example, and without limitation, generating fitness class content may include modifying class action data based on a class action modifier. Modifying class action data may include inserting additional data specified by a class action data modifier at one or more determined points into class action data.

Still referring to FIG. 1, generating fitness class content may include selecting an element of historical class action data from a library containing historical class action data. Such a selection may be based on a class action data modifier. For example, a class action data modifier may act as a filter. A computing device may be configured to filter a library and select a historical data that meets current needs. In some embodiments, a computing device may update historical class action data based on the class action data modifier.

Still referring to FIG. 1, generating fitness class content may include assembling fitness class content from historical class action data, current class action data (such as from an ongoing fitness class), and/or one or more UI elements. In a non-limiting example, fitness class content may be assembled by combining historical video data with current audio data, such as audio data from a live instructor. In a non-limiting example, fitness class content may be assembled by combining historical video data with live video data, such as by displaying a live video of an instructor performing a pose, and besides that, displaying historical videos of instructors performing the pose from different angles. In a non-limiting example, fitness class content may be assembled by combining a live video with a UI element, such as a UI element indicating where strain should be felt when performing a pose. In a non-limiting example, an instructional video may be assembled from historical video of an instructor (such as video of an instructor performing a pose), current video of a class participant, and a UI element (such as a UI element displayed over the current video of the class participant, providing feedback to the class participant).

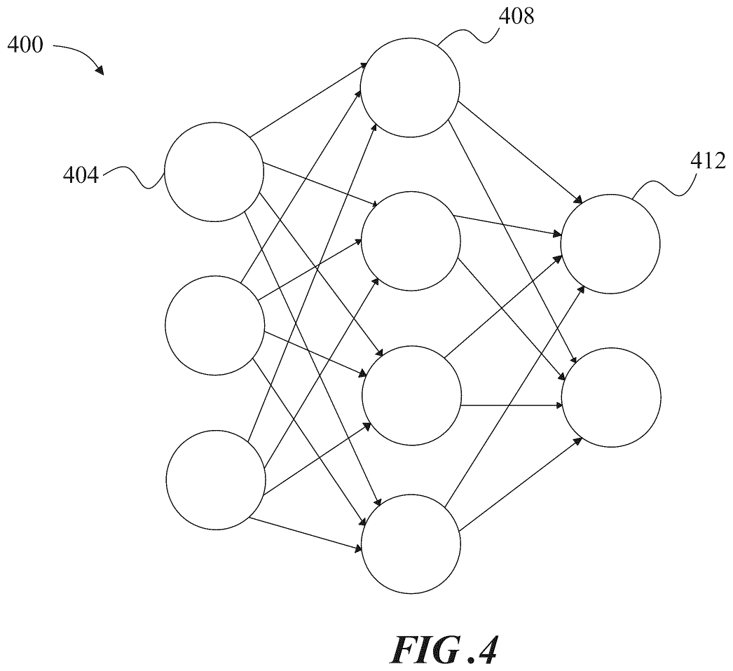

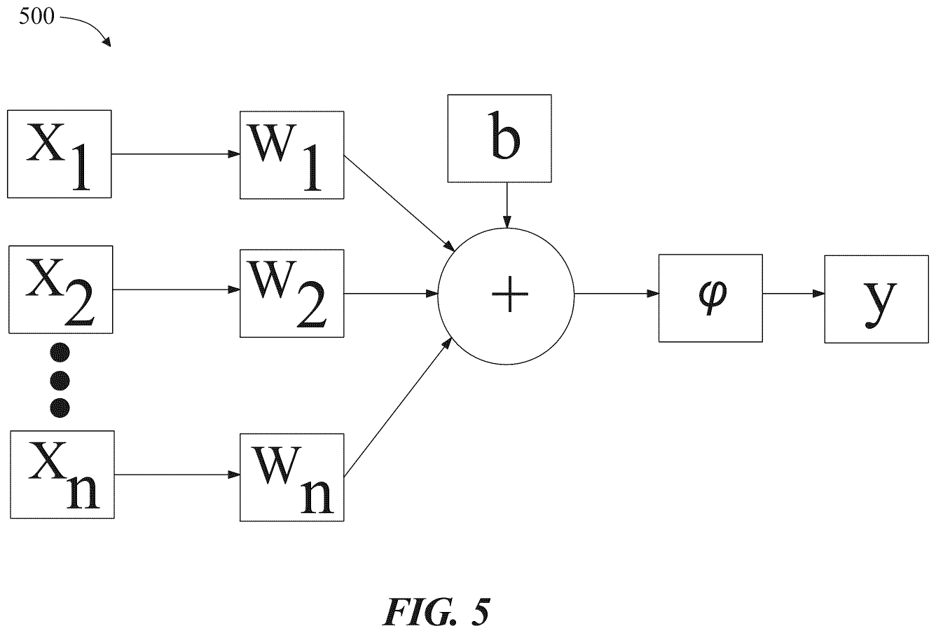

Continuing with reference to FIG. 1, in a further non-limiting embodiment, generating fitness class content may include combining with, applying to, or otherwise implementing into class action data 128 described herein. In some cases, generating fitness class content may include overlay class action data modifier on top of class action data (e.g., video clip of user's body), wherein the class action data modifier may include, without limitation, a desired form on particular pose or movement for a user on a video feed. In some cases, desired form may be included in one or more supplementary videos generated based on class action data using one or more generative machine learning models described above. In a non-limiting example, such overlay may include a stick figure, avatar, dummy image, or other visual representation that illustrates the proper alignment or posture for a particular yoga pose or movement. In some cases, overlay may also be scaled and adapted to specific user; for instance, and without limitation, processor 116 may take into account data describing one or more attributes of individual user e.g., height, body proportions, gender, or any other relevant factors. In an embodiment, scaling of the overlay may be achieved through one or more computer vision techniques, anthropometric modeling, and/or machine learning algorithms. In a non-limiting example, processor 116 may be configured to generate a customized overlay that aligns with user's unique physique using a deep neural network as described in further detail below with reference to FIGS. 4-5, trained using training data containing a plurality of body measurements, postures, and/or alignments as input correlated to a plurality of desired pose representations as output. In another non-limiting example, processor 116 may utilize skeletal tracking and geometric transformation algorithms to adapt the overlay to the user's specific body proportions and movements. In some cases, processor 116 may be configured to identify a plurality of key anatomical landmarks such as, without limitations, joints, spine alignment, and/or the like, and map the plurality of key anatomical landmarks to a standardized model such as, without limitation, a stick figure or avatar. Mapped model may then be scaled and transformed to match user's actual dimensions and pose, ensuring that the overlay provides an accurate and intuitive visual guide. Additionally, or alternatively, gender-specific adjustments, biomechanical constraints, and other individualized factors may be incorporated into the scaling process, further enhancing the overlay's relevance and effectiveness Further, overlay may be registered to view feed using field coordinate system as described above to ensure the generated visual representation maintains its spatial relationships with users' body as they move. In some cases, overlay may be animated or dynamically adjusted to guide user through a sequence of poses and provide real-time feedback and correction, In a non-limiting example, if a user's alignment deviates from the movement template, the overlay may change color, flash, vibrate or provide other visual cues to signal the error.

Still referring to FIG. 1, an apparatus 100 may include a display 120. A computing device 108 may be configured to transmit fitness class content to a display. For example, a computing device may be communicatively connected to a video capture device, and a computing device may include at least a processor and a memory communicatively connected to the at least processor, the memory containing instructions configuring the at least processor to transmit fitness class content to a display.

Still referring to FIG. 1, a display may include, for example, a smartphone screen, a computer screen, or a tablet screen. A display may be configured to provide a visual interface. A visual interface may include one or more virtual interactive elements such as, without limitation, buttons, menus, and the like. A display may include one or more physical interactive elements, such as buttons, a computer mouse, or a touchscreen, that allow a user to input data, such as visual interface interaction data, into the display. Interactive elements may be configured to enable interaction between a user and a computing device. In a non-limiting example, a visual interface may include a menu that is configured to allow a user to manually select a class action data modifier from a plurality of class action data modifiers generated by a computing device. In another non-limiting example, a user may input a request for a tutorial on how to perform a pose, and a computing device may generate a class action data modifier in order to provide a tutorial, such as a video tutorial including historical class action data. In another non-limiting example, a user may input a request for additional verbal instruction of how to perform a pose, and a computing device may generate a class action data modifier in order to provide verbal instruction, such as a class action data modifier for notifying an instructor that additional verbal instruction is needed.

Still referring to FIG. 1, an apparatus may include more than one display. In some embodiments, an apparatus may include 1, 2, 3, 4, 5, or more displays. In some embodiments, an apparatus may include a first display and a second display mounted next to the first display. In some embodiments, a class action data modifier modifies the content shown on a subset of displays. In a non-limiting example, a class action data modifier may modify the content shown on a first display but not the content shown on a second display. In a non-limiting example, a user may input a request for a tutorial, and a computing device may generate a class action data modifier that displays a tutorial on a first display but not a second display.

Still referring to FIG. 1, in some embodiments, a visual interface may be configured to enable communication between two entities. For example, and without limitation, a visual interface may display or output post-class feedback of a fitness class, generated and/or input by a first entity (e.g., an instructor, instructor assistant, and the like), to a second entity (e.g., a student, a group of students, all students in the class, and the like).

Still referring to FIG. 1, a display may be configured to transmit visual interface interaction data to a computing device. As used herein, “visual interface interaction data” is data input by a user using a visual interface. In some embodiments, a computing device may generate fitness class content as a function of visual interface interaction data. In some embodiments, a memory contains instructions configuring an at least processor to generate fitness class content as a function of visual interface interaction data. In some embodiments, fitness class content generated as a function of visual interface interaction data is generated based on categorization of historical class action data and/or current class action data. For example, if a class participant requests further guidance, then an apparatus may determine what the class is currently being instructed to do based on machine learning categorization of class action data and may display an instructional video including historical class action data, wherein the historical class action data is categorized as matching the current instruction.

Still referring to FIG. 1, in some embodiments, a display includes an audio interface. In some embodiments, an audio interface may include a microphone. In some embodiments, a display may be configured to transmit audio interface interaction data to a computing device. As used herein, “audio interface interaction data” is data input by a user using an audio interface. Audio interface interaction data may be interpreted using a language model, as described above.

Still referring to FIG. 1, in some embodiments, class action data may be retrieved from a storage device and displayed to a user as a result of user input. For example, an instructor may request a video replay of a class and may use the replay to provide customized feedback to individual class participants.

Still referring to FIG. 1, a visual interface may include a graphical user interface (GUI). A visual interface may be configured to display fitness class content. A visual interface may be configured to display class action data.

Still referring to FIG. 1, in some embodiments, data related to interaction within the visual interface may be saved as class action data and used by systems and methods described in this disclosure.

Still referring to FIG. 1, in some embodiments, a notification is displayed to a class participant based on categorization of class action data, such as categorization of class action data using a machine learning model. As an example, if a machine learning model categorizes audio class action data as a highly complex instruction, then a notification may be displayed to the instructor informing them that the instruction is likely too complex. As another example, if a machine learning model categorizes audio class action data as an instruction to perform a pose, but a machine learning model does not categorize video class action data as including a demonstration of the pose, then a notification may be displayed to the instructor informing them that a demonstration would be helpful.

Still referring to FIG. 1, classes may be administered, without limitation, as disclosed in U.S. patent application Ser. No. 18/368,947, filed on Sep. 15, 2023, and titled “APPARATUS FOR CLASS ADMINISTRATION AND A METHOD OF USE,” the entirety of which is hereby incorporated by reference. Classes may be administered, without limitation, using classroom configurations and/or components as described in U.S. patent application Ser. No. 18/369,023, filed on Sep. 15, 2023, and titled “FITNESS CLASSROOM ASSEMBLY AND A METHOD OF USE,” the entirety of which is hereby incorporated by reference. Classes may be scheduled, without limitation, as disclosed in U.S. patent application Ser. No. 18/368,915, filed on Sep. 15, 2023, and titled “APPARATUS FOR CLASSROOM SCHEDULING AND METHOD OF USE,” the entirety of which is incorporated herein by reference.

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm instantiated in hardware or software logic, data structures, and/or functions that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With further reference to FIG. 2, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Still referring to FIG. 2, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value.

As a non-limiting example, and with further reference to FIG. 2, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 2, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 2, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include class action data as described above as inputs, class action data modifier as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

With further reference to FIG. 2, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 2, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 232 may not require a response variable; unsupervised processes 232 may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 2, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 2, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 2, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 2, one or more processes or algorithms described above may be performed by at least a dedicated hardware unit 236. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 236 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 236 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 236 to perform one or more operations described herein, such as evaluation of model and/or algorithm outputs, one-time or iterative updates to parameters, coefficients, weights, and/or biases, and/or any other operations such as vector and/or matrix operations as described in this disclosure.

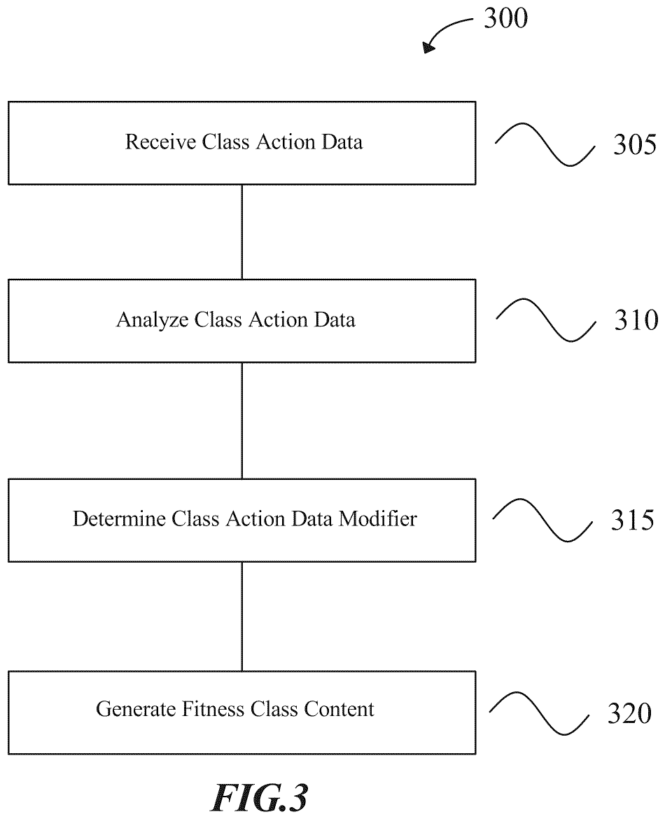

Now referring to FIG. 3, an exemplary embodiment of a method 300 of fitness class generation is illustrated. At step 305, a computing device receives class action data from a video capture device; this may be implemented, without limitation, as described above in reference to FIGS. 1-2. In some embodiments, a method further includes receiving class action data from a video storage device.

Still referring to FIG. 3, at step 310, a computing device analyzes class action data using an action model; this may be implemented, without limitation, as described above in reference to FIGS. 1-2. In some embodiments, an action model is configured to categorize a pose depicted by the class action data using a computer vision model. In some embodiments, an action model is configured to interpret speech using a language model.

Still referring to FIG. 3, at step 315, a computing device determines a class action data modifier based on an analysis of class action data; this may be implemented, without limitation, as described above in reference to FIGS. 1-2. In some embodiments, computing device determines class action data modifier using a machine learning model trained on past class action data.

Still referring to FIG. 3, at step 320, a computing device generates fitness class content as a function of a class action data modifier and class action data; this may be implemented, without limitation, as described above in reference to FIGS. 1-2. In some embodiments, computing device generates fitness class content as a function of class action data modifier and visual interface interaction data. In some embodiments, computing device receives class action data from a live fitness class. In some embodiments, computing device transmits fitness class content to a display capable of being viewed by live fitness class. In some embodiments, a method further includes receiving visual interface interaction data from a display.

Referring now to FIG. 4, an exemplary embodiment of neural network 400 is illustrated. A neural network 400 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 404, one or more intermediate layers 408, and an output layer of nodes 412. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

With continued reference to FIG. 4, in an embodiment, neural network may include a deep neural network (DNN). As used in this disclosure, a “deep neural network” is defined as a neural network with two or more hidden layers. In a non-limiting example, neural network may include a convolutional neural network (CNN). Generating class data, instructor data/feedback, or any other data described above may include training CNN using training data such as any training data described above with reference to FIGS. 1-2, and generating class data and/or instructor data/feedback using trained CNN. A “convolutional neural network,” for the purpose of this disclosure, is a neural network in which at least one hidden layer is a convolutional layer that convolves inputs to that layer with a subset of inputs known as a “kernel,” along with one or more additional layers such as pooling layers, fully connected layers, and the like. In some cases, CNN may include, without limitation, a deep neural network (DNN) extension. Mathematical (or convolution) operations performed in the convolutional layer may include convolution of two or more functions, where the kernel may be applied to input data e.g., frames of given video clips through a sliding window approach. In some cases, convolution operations may enable processor 116 to detect local/global patterns, edges, textures, and any other features described herein within each frames. Features may be passed through one or more activation functions, such as without limitation, Rectified Linear Unit (ReLU), to introduce non-linearities into the data generation process. Additionally, or alternatively, CNN may also include one or more pooling layers, wherein each pooling layer is configured to reduce the dimensionality of input data while preserving essential features within the input data. In a non-limiting example, CNN may include one or more pooling layer configured to reduce the dimensions of feature maps by applying downsampling, such as max-pooling or average pooling, to small, non-overlapping regions of one or more features.

Still referring to FIG. 4, CNN may further include one or more fully connected layers configured to combine features extracted by the convolutional and pooling layers as described above. In some cases, one or more fully connected layers may allow for higher-level pattern recognition. In a non-limiting example, one or more fully connected layers may connect every neuron (i.e., node) in its input to every neuron in its output, functioning as a traditional feedforward neural network layer. In some cases, one or more fully connected layers may be used at the end of CNN to perform high-level reasoning and produce the final output such as, without limitation, class data such as yoga poses examples. Further, each fully connected layer may be followed by one or more dropout layers configured to prevent overfitting, and one or more normalization layers to stabilize the learning process described herein.

With continued reference to FIG. 4, in an embodiment, training the neural network such as CNN may include selecting a suitable loss function to guide the training process. In a non-limiting example, a loss function, measures the difference between the predicted class action data modifiers and the ground truth class action data modifiers in the training data, may be used, such as, without limitation, mean squared error (MSE) or a custom loss function may be designed for one or more embodiments described herein. Additionally, or alternatively, optimization algorithms, such as stochastic gradient descent (SGD), may then be used to adjust the CNN's parameters to minimize such loss. In a further non-limiting embodiment, instead of directly generating instruction data, Neural network may be trained as a regression model to predict numeric values within class action data modifiers. Additionally, CNN may be extended with additional deep learning techniques, such as recurrent neural networks (RNNs) or attention mechanism, to capture additional features and/or data relationships within input data. These extensions may further enhance the accuracy and robustness of the determination class action data modifier described herein.

Referring now to FIG. 5, an exemplary embodiment of a node 500 of a neural network is illustrated. A node may include, without limitation a plurality of inputs xi that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tan h (hyperbolic tangent) function, of the form

$$\frac{{e}^{x} - {e}^{- x}}{{e}^{x} + {e}^{- x}} ,$$

a tan h derivative function such as ƒ(x)=tan h²(x), a rectified linear unit function such as ƒ(x)=max(0, x), a “leaky” and/or “parametric” rectified linear unit function such as ƒ(x)=max (ax, x) for some a, an exponential linear units function such as

$$f ( x ) = \{ \begin{matrix}x for x \geq 0 \\ α ( {e}^{x} - 1 ) for x < 0\end{matrix}$$

for some value of a (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid(x), a Gaussian error linear unit function such as f(x)=a (1+tan h (\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xi that may be used as activation functions. As a non-limiting and illustrative example, node may perform a weighted sum of inputs using weights wᵢ that are multiplied by respective inputs xi. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xi may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

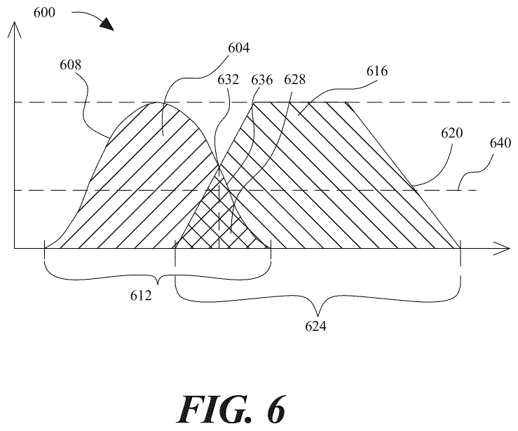

Referring to FIG. 6, an exemplary embodiment of fuzzy set comparison 600 is illustrated. A first fuzzy set 604 may be represented, without limitation, according to a first membership function 608 representing a probability that an input falling on a first range of values 612 is a member of the first fuzzy set 604, where the first membership function 608 has values on a range of probabilities such as without limitation the interval [0,1], and an area beneath the first membership function 608 may represent a set of values within first fuzzy set 604. Although first range of values 612 is illustrated for clarity in this exemplary depiction as a range on a single number line or axis, first range of values 612 may be defined on two or more dimensions, representing, for instance, a Cartesian product between a plurality of ranges, curves, axes, spaces, dimensions, or the like. First membership function 608 may include any suitable function mapping first range 612 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , & for x > c and x < a \\ \frac{x - a}{b - a} , & for a \leq x < b \\ \frac{c - x}{c - b} , & if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

Still referring to FIG. 6, first fuzzy set 604 may represent any value or combination of values as described above, including output from one or more machine-learning models, such as difficulty of exercise movement, ease with which it can be understood visually, and statistical prevalence of a phrase, and a predetermined class, such as without limitation, the degree to which instruction of a movement is difficult to understand. A second fuzzy set 616, which may represent any value which may be represented by first fuzzy set 604, may be defined by a second membership function 620 on a second range 624; second range 624 may be identical and/or overlap with first range 612 and/or may be combined with first range via Cartesian product or the like to generate a mapping permitting evaluation overlap of first fuzzy set 604 and second fuzzy set 616. Where first fuzzy set 604 and second fuzzy set 616 have a region 628 that overlaps, first membership function 608 and second membership function 620 may intersect at a point 632 representing a probability, as defined on probability interval, of a match between first fuzzy set 604 and second fuzzy set 616. Alternatively, or additionally, a single value of first and/or second fuzzy set may be located at a locus 636 on first range 612 and/or second range 624, where a probability of membership may be taken by evaluation of first membership function 608 and/or second membership function 620 at that range point. A probability at 628 and/or 632 may be compared to a threshold 640 to determine whether a positive match is indicated. Threshold 640 may, in a non-limiting example, represent a degree of match between first fuzzy set 604 and second fuzzy set 616, and/or single values therein with each other or with either set, which is sufficient for purposes of the matching process; for instance, threshold may indicate a sufficient degree of overlap between an output from one or more machine-learning models and/or difficulty of exercise movement, ease with which it can be understood visually, and statistical prevalence of a phrase and a predetermined class, such as without limitation the degree to which instruction of a movement is difficult to understand categorization, for combination to occur as described above. Alternatively, or additionally, each threshold may be tuned by a machine-learning and/or statistical process, for instance and without limitation as described in further detail below.

Further referring to FIG. 6, in an embodiment, a degree of match between fuzzy sets may be used to classify difficulty of exercise movement, ease with which it can be understood visually, and statistical prevalence of a phrase and a predetermined class with the degree to which instruction of a movement is difficult to understand. For instance, if the degree to which instruction of a movement is difficult to understand has a fuzzy set matching difficulty of exercise movement, ease with which it can be understood visually, and statistical prevalence of a phrase and a predetermined class fuzzy set by having a degree of overlap exceeding a threshold, apparatus may classify the difficulty of exercise movement, ease with which it can be understood visually, and statistical prevalence of a phrase and a predetermined class as belonging to the degree to which instruction of a movement is difficult to understand categorization. Where multiple fuzzy matches are performed, degrees of match for each respective fuzzy set may be computed and aggregated through, for instance, addition, averaging, or the like, to determine an overall degree of match.

Still referring to FIG. 6, in an embodiment, a difficulty of exercise movement, ease with which it can be understood visually, and statistical prevalence of a phrase and a predetermined class may be compared to multiple the degree to which instruction of a movement is difficult to understand categorization fuzzy sets. For instance, difficulty of exercise movement, ease with which it can be understood visually, and statistical prevalence of a phrase and a predetermined class may be represented by a fuzzy set that is compared to each of the multiple degree to which instruction of a movement is difficult to understand categorization fuzzy sets; and a degree of overlap exceeding a threshold between the difficulty of exercise movement, ease with which it can be understood visually, and statistical prevalence of a phrase and a predetermined class fuzzy set and any of the multiple degree to which instruction of a movement is difficult to understand categorization fuzzy sets may cause apparatus to classify the difficulty of exercise movement, ease with which it can be understood visually, and statistical prevalence of a phrase and a predetermined class as belonging to the degree to which instruction of a movement is difficult to understand categorization. For instance, in one embodiment there may be two degree to which instruction of a movement is difficult to understand categorization fuzzy sets, representing respectively the degree to which instruction of a movement is difficult to understand for beginners categorization and an the degree to which instruction of a movement is difficult to understand for experienced individuals categorization. First the degree to which instruction of a movement is difficult to understand categorization may have a first fuzzy set; Second the degree to which instruction of a movement is difficult to understand categorization may have a second fuzzy set; and difficulty of exercise movement, ease with which it can be understood visually, and statistical prevalence of a phrase and a predetermined class may have an difficulty of exercise movement, ease with which it can be understood visually, and statistical prevalence of a phrase and a predetermined class fuzzy set. Apparatus, for example, may compare an difficulty of exercise movement, ease with which it can be understood visually, and statistical prevalence of a phrase and a predetermined class fuzzy set with each of the degree to which instruction of a movement is difficult to understand for beginners categorization fuzzy set and degree to which instruction of a movement is difficult to understand for advanced individuals categorization fuzzy set, as described above, and classify a difficulty of exercise movement, ease with which it can be understood visually, and statistical prevalence of a phrase and a predetermined class to either, both, or neither of the degree to which instruction of a movement is difficult to understand for beginners categorization or degree to which instruction of a movement is difficult to understand for advanced individuals categorization. Machine-learning methods as described throughout may, in a non-limiting example, generate coefficients used in fuzzy set equations as described above, such as without limitation x, c, and σ of a Gaussian set as described above, as outputs of machine-learning methods. Likewise, difficulty of exercise movement, ease with which it can be understood visually, and statistical prevalence of a phrase and a predetermined class may be used indirectly to determine a fuzzy set, as difficulty of exercise movement, ease with which it can be understood visually, and statistical prevalence of a phrase and a predetermined class fuzzy set may be derived from outputs of one or more machine-learning models that take the difficulty of exercise movement, ease with which it can be understood visually, and statistical prevalence of a phrase and a predetermined class directly or indirectly as inputs.

As used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

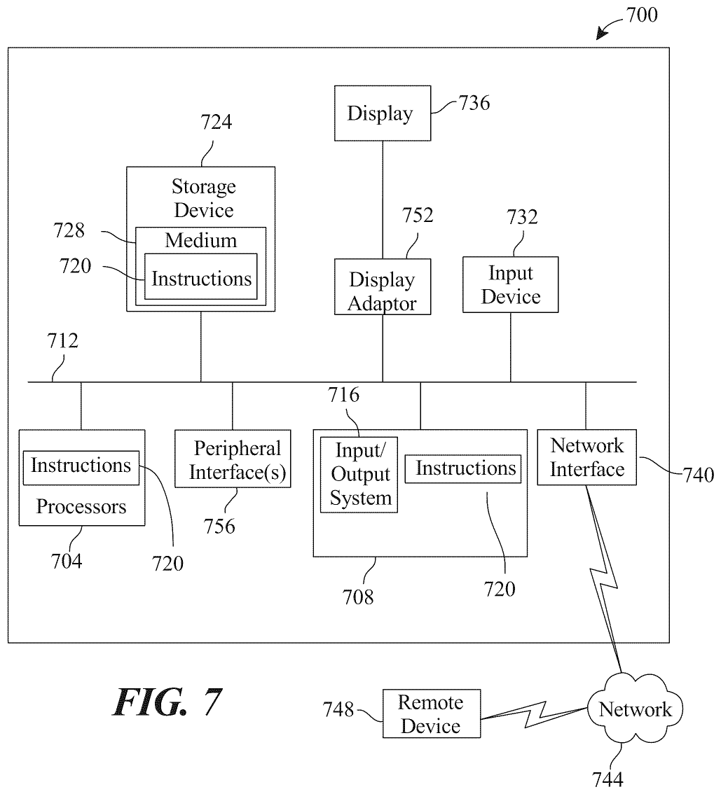

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 704 may be organized according to Von Neumann and/or Harvard architecture as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 708 may include various components (e.g., machine-readable media) including, but not limited to, a random-access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

A user may also input commands and/or other information to computer system 300 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve systems and methods according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for fitness class generation, the apparatus comprising:
a video capture device; and
a computing device communicatively connected to the video capture device, wherein the computing device comprises:
at least a processor; and
a memory communicatively connected to the at least processor, the memory containing instructions configuring the at least processor to:
receive class action data from the video capture device;
analyze the class action data using an action module;
determine a class action data modifier based on an analysis of the class action data; and
generate fitness class content as a function of the class action data modifier.

2. The apparatus of claim 1 further comprising a display, wherein the memory contains instructions configuring the at least processor to transmit fitness class content to the display, wherein the display is configured to provide a visual interface, wherein the display is configured to transmit visual interface interaction data to the computing device.

3. The apparatus of claim 2, wherein the memory contains instructions configuring the at least processor to generate fitness class content as a function of the class action data modifier and the visual interface interaction data.

4. The apparatus of claim 1, further comprising a display, wherein the memory contains instructions configuring the at least processor to transmit fitness class content to the display, wherein the memory contains instructions configuring the at least processor to receive class action data on a live fitness class from the video capture device, wherein the display is capable of being viewed by the live fitness class.

5. The apparatus of claim 1, further comprising a storage device, wherein the memory contains instructions configuring the at least processor to receive class action data from the storage device.

6. The apparatus of claim 1, wherein the memory contains instructions configuring the at least processor to generate fitness class content as a function of the class action data modifier and the class action data.

7. The apparatus of claim 1, wherein the action module is configured to categorize a pose depicted by the class action data using a computer vision model.

8. The apparatus of claim 1, wherein the action module is configured to interpret speech using a language model.

9. The apparatus of claim 1, wherein determining a class action data modifier based on an analysis of the class action data utilizes a machine learning model trained on past class action data.

10. The apparatus of claim 1, wherein fitness class content comprises class action data from a first fitness class and class action data from a second fitness class.

11. A method of generating fitness class content, the method comprising:
receiving, by a computing device, class action data from a video capture device;
analyzing, by the computing device, the class action data using an action module;
determining, by the computing device, a class action data modifier based on an analysis of the class action data; and
generating, by the computing device, fitness class content as a function of the class action data modifier and the class action data.

12. The method of claim 11, further comprising transmitting fitness class content to a display.

13. The method of claim 12, further comprising receiving visual interface interaction data from a display.

14. The method of claim 13, wherein fitness class content is generated as a function of the class action data modifier and the visual interface interaction data.

15. The method of claim 12, wherein the class action data is data from a live fitness class, wherein the fitness class content is transmitted to a display capable of being viewed by the live fitness class.

16. The method of claim 11, further comprising receiving class action data from a storage device.

17. The method of claim 11, wherein fitness class content is generated as a function of the class action data modifier and the class action data.

18. The method of claim 11, wherein the action module is configured to categorize a pose depicted by the class action data using a computer vision model.

19. The method of claim 11, wherein the action module is configured to interpret speech using a language model.

20. The method of claim 11, wherein determining a class action data modifier based on an analysis of the class action data utilizes a machine learning model trained on past class action data.
